(19) United States
(12) Patent Application Publication
(10) Pub. No.: US 2015/0227707 A1
(43) Pub. Date: Aug. 13, 2015

(54) SYSTEM AND METHOD FOR CLINICAL PROCEDURE ALERT NOTIFICATIONS

(71) Applicant: The Adrien Group, LLC, Glenwood Springs, CO (US)

(72) Inventors: Frank Laws, Glenwood Springs, CO (US); Abe Khaleghi, Houston, TX (US); Sanjay Parikh, Houston, TX (US); Chris Norton, Houston, TX (US); Robert Green, Phoenix, AZ (US)

(73) Assignee: The Adrien Group, LLC, Glennwood Springs, CO (US)

(21) Appl. No.: 14/168,261

(22) Filed: Jan. 30, 2014

Related U.S. Application Data
(63) Continuation of application No. 14/147,505, filed on Jan. 4, 2014.

(51) Int. Cl. G06F 19/00

(52) U.S. Cl. CPC G06F 19/3418; G06F 19/3406

(57) ABSTRACT

Described herein is system and method for enabling real-time alerts and notifications for clinical procedures. In one embodiment, a notification system is created based on a pre-existing template. The user interface receives alerts and notifications from the system, and may in turn, initiate notifications and alerts to other users with different devices. Individual medical practices can create custom templates in the system to meet their specific requirements. Multiple methods of alerting are supported and multiple user devices are supported such as mobile devices, motion sensing devices, optical head-mounted displays, etc.

### BACKGROUND OF THE INVENTION

1. Technical Field

Embodiments of the invention relates to clinical informatics and a clinical informatics platform for health care. Example embodiments of the present invention include sending real-time alerts and notification of the status in medical procedures to mobile computing devices.

2. Background

Thousands of medical diagnoses and procedures are performed in hospitals and urgent care centers daily. Many of those procedures have a vastly improved success rate when tasks are performed expeditiously. An example of this is a patient that is diagnosed with an ischemic stroke and may be a candidate for tPA treatment; such treatment must be administered generally within 3 hours of the onset of symptoms, therefore speed of completing the required tasks of patient admitting, testing, and diagnosis is critical to the treatment and probable success of patient recovery. Another example of critical timing in patient care is cardiac catheterization. Again, managing and reducing the time from diagnosis to treatment is directly related to increased recovery rates.

Notification of medical personnel is critical in a multi-step procedure. Personnel that are required need to be notified in advanced to be prepared for a patient or procedure to minimize the waiting time between procedures.

A variety of computer-based solutions have been developed to assist clinicians in the care of patients. Such solutions provide clinicians diagnostic information and allow clinicians to manage patient activities. However, many of these solutions have not been well constructed. In particular, most solutions provide some form of notification, however, they have not caught up with the advances in mobile computing uses and do not offer a comprehensive notification system. As a result, many multi-step procedures are not carried out in the most effective time manner.

To increase the efficiency of multiple step procedures, real-time communication is needed to provide alerts and notifications, and reduce the lag time between tasks in a procedure. Thus, there is a need in the art for a system of intra-clinic communication that would deliver real-time status updates and notifications. Specifically, there is a need for a system that is able to inform clinic personnel what steps are in process during a medical procedure. It is to these ends that the present invention has been developed.

### DEFINITIONS

Portable Computing Device, Mobile Computing Device, Mobile Communications Device: Mobile computing is a form of human-computer interaction by which a computer is expected to be transported during normal usage. Portable Computing Device, Mobile Computing Device, and Mobile Communications Device shall have the same meaning in the specifications and claims. Mobile computing has three aspects: mobile communication, mobile hardware, and mobile software. The first aspect addresses communication issues in ad-hoc and infrastructure networks as well as communication properties, protocols, data formats and concrete technologies. The second aspect is on the hardware, e.g., mobile devices or device components. The third aspect deals with the characteristics and requirements of mobile applications.

Many types of mobile computers have been introduced since the 1990s including the:
a. Wearable computer
b. Personal digital assistant/enterprise digital assistant
c. Smartphone
d. Carputer
e. Ultra-Mobile PC
f. Tablet computer
g. A watch or glasses with broadband access, touch screen technology, capability to run custom applications, capability to send or receive messages or signals, or any combination thereof.

Mobile Computing Device or Mobile Communications Device: For the purposes of this document, “mobile computing device” or “mobile communications device” shall mean any remote device that is portable and has either phone, computing, or internet access capability, including but not limited to: a smartphone, or any mobile, cellular, PDA, or portable device or portable computing device as previously defined.

Augmented Reality Devices: Augmented reality (AR) is a live, direct or indirect, view of a physical, real-world environment whose elements are augmented (or supplemented) by computer-generated sensory input such as sound, video, graphics or GPS data. It is related to a more general concept called mediated reality, in which a view of reality is modified (possibly even diminished rather than augmented) by a computer. As a result, the technology functions by enhancing one's current perception of reality. By contrast, virtual reality replaces the real world with a simulated one. Augmentation is conventionally in real-time and in semantic context with environmental elements, such as sports scores on TV during a match. With the help of advanced AR technology (e.g. adding computer vision and object recognition) the information about the surrounding real world of the user becomes interactive and digitally manipulable. Artificial information about the environment and its objects can be overlaid on the real world.

Speech Recognition Devices: In computer science, speech recognition (SR) is the translation of spoken words into text. It is also known as “automatic speech recognition”, “ASR”, “computer speech recognition”, “speech to text”, or just “STT”.
1) Some SR systems use “speaker independent speech recognition” while others use “training” where an individual speaker reads sections of text into the SR system. These systems analyze the person's specific voice and use it to fine tune the recognition of that person's speech, resulting in more accurate transcription. Systems that do not use training are called “speaker independent” systems. Systems that use training are called “speaker dependent” systems.

Voice Actions are a series of spoken commands that a computing device using voice

Motion Sensing Devices: Motion detection is the process of detecting a change in position of an object relative to its surroundings or the change in the surroundings relative to an object. Motion detection can be achieved by both mechanical and electronic methods. When motion detection is accomplished by natural organisms, it is called motion perception.

Motion can be detected by:
a) Infrared (Passive and active sensors)
b) Optics (video and camera systems)
c) Radio Frequency Energy (radar, microwave and tomographic motion detection)
d) Sound (microphones and acoustic sensors)
e) Vibration (triboelectric, seismic, and inertia-switch sensors)
f) Magnetism (magnetic sensors and magnetometers)

Optical Head-Mounted Display (OHMD): Optical head-mounted display (OHMD) is a wearable display that has the capability of reflecting projected images as well as allowing the user to optically see-through it. Head Mounted Displays have been used in various forms to assist surgeons and other medical personnel to support and improve visualization of the work site. Historically, many of these were of inadequate resolution, bulky, cave-like and heavy and they, deservedly, received limited acceptance. Recent availability of high-resolution displays, lighter structures and the various see-though designs that merge both real world and registered synthetic imagery have significantly increased the benefits of these devices for the medical community.

A Gesture is a touch or movement on a computing or mobile device that operates as commands to the device or to software on the device. On touchscreen displays, multi-touch refers to the ability to simultaneously register three or more distinct positions of input touches. It is often used to describe other, more limited implementations, like Gesture-Enhanced Single-Touch, Dual-Touch or real Multi-Touch. The interaction of touch and movement on surfaces is a function on electronic visual displays and touchpad pointing devices to interact with content. It is an intermediary connection and detection method from hardware to computer software, to enact a user's intention.

Air Gestures: An Air Gesture is similar to a Gesture as defined above, except that there is no contact required on a touch screen display on a mobile device. An Air Gesture is able to use a screen on a mobile device or portable computing device without direct contact, and can perform all of the same functions performed by Gestures.

Voice Actions are a series of spoken commands that lets a user control a computing device using his voice

### SUMMARY OF THE INVENTION

One embodiment of the present invention may comprise a system and method adapted to provide real-time notification, alerts, and updates to inform clinicians what steps are in process during a medical procedure.

Another embodiment of the invention may comprise providing a template of notification alerts that can be customized and interfaced into any third party medical application. The system may add new notification methods to an existing system. In addition, the system may alert one or more devices; the device users may initiate an alert or event in the system to cause an alert or notification to one or more additional devices. The notifications may contain status information pertaining to the patient being monitored. Additionally, users may attach documents to the patient timeline for the purposes of archiving relevant documentation of medical procedures; various file types may be attached, including images, videos, audio files, patient chart files, and any other file type as part of the notification process.

Another embodiment of the invention may comprise a cloud based service operating the system, and medical practices that use the system need only to use their own input devices without the need to install any software on their own local network.

Another embodiment of the invention may comprise providing a graphical user interface and method of input for various types of devices used in the medical field. All mobile computing devices may be used, as well as optical head-mounted display (OHMD), motion sensing devices, voice recognition devices, and augmented reality devices. Any input method supported by the individual device may be used, including keyboard, touchscreen, voice commands, air gestures, and other methods that are used by the individual device. Each individual device type or device may allow for attaching video files, audio files, or other files that will be attached to and become a permanent part of the patient medical record.

### BRIEF DESCRIPTION OF THE DRAWINGS

The above and other objects, features, and advantages of the embodiments of the present invention are further described in the detailed description which follows, with reference to the drawings by way of non-limiting exemplary embodiments of the present invention, wherein like reference numerals represent similar parts of the present invention throughout the several views and wherein:

FIG. 1 illustrates a medical notification system according to one embodiment of the invention. A mobile computing device sends a notification or receives an alert from a cloud-based host server.

FIG. 2 illustrates a medical notification system according to one embodiment of the invention. A mobile computing device sends a notification or receives an alert from a local server.

FIG. 3 illustrates a flowchart that depicts a method that may be carried out in connection with the embodiments described herein.

FIG. 4 illustrates various input methods that may be used according to one embodiment of the invention.

FIG. 5 illustrates various notification methods according to one embodiment of the invention. Various supported devices may input and receive alerts and notifications.

FIG. 6 illustrates a flowchart that depicts a method that may be carried out in connection with the embodiments described herein.

FIG. 7 illustrates a sample user interface on a mobile computing device that may be carried out in connection with the embodiments described herein.

FIG. 8 illustrates a sample user interface on a mobile computing device that may be carried out in connection with the embodiments described herein.

FIG. 9 illustrates a sample user interface on a mobile computing device that may be carried out in connection with the embodiments described herein.

### DETAILED DESCRIPTION OF THE INVENTION

Although the detailed description herein contains many specifics for the purposes of illustration, anyone of ordinary skill in the art will appreciate that many variations and alterations to the following details are within the scope of the embodiments described herein. Thus, the following illustrative embodiments are set forth without any loss of generality to, and without imposing limitations upon, the claimed invention.

In various embodiments, a system, method and non-transitory, tangible, computer readable storage medium are adapted to provide intra-clinic communication that delivers real-time status updates to inform clinicians what steps are in process during a medical procedure is disclosed. The embodiment may be adapted to provide a system and method for the medical personnel to share an application that tracks the steps and timeline of a patient procedure. System components include a server, a database, computing devices, client user interfaces, templates, and a means for computing devices to communicate with the server.

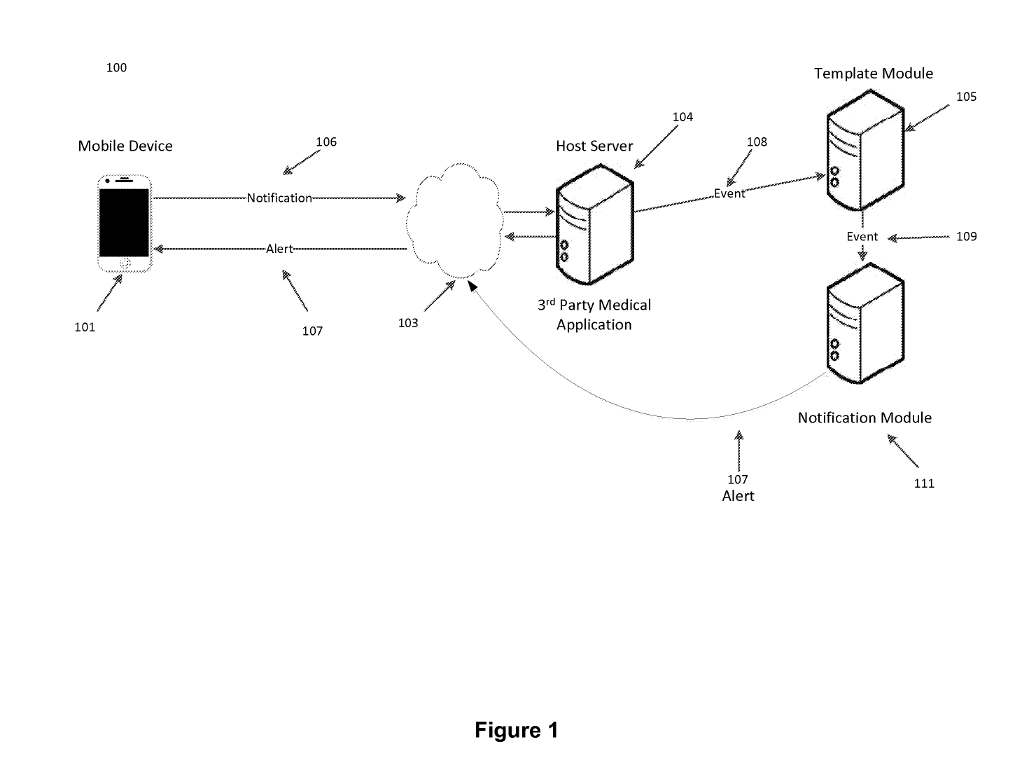

FIG. 1 illustrates one embodiment of the system 100. Clinicians may use a computing device or mobile computing device 101 as shown in this embodiment. The term “clinician” refers to a medical professional that uses the system, and the term “user” will be used herein to refer to a clinician. The user of the mobile device 101 receives an alert 107 over the internet 103 from the host server 104. It should be appreciated that communications over the internet may be accomplished by wired or wireless means, and alternately a cellular connection may be used. In response to an external event from a third party medical application, the host server 104 receives and validates the event request 108 and sends the event request to the template module 105. It should be appreciated that a distributed file system may be used in place of a database. The template module is configured to store templates of notification procedures, forwards the event request 108 with event information 109 to the notification module 111. The template module and notification module are operationally coupled to the server.

It should be understood that the system 100 may employ a single powerful server to perform the functions of both the host server 104, template module 105, and notification module 111, or any other portion of the system 100. Alternatively, multiple computers may be employed to provide the server functionality and/or the template module functionality. The host server 104, template module 105, and notification module 111 may reside behind a firewall or other forms of security measures. Data backup servers may be used as well as other data storage services such as cloud servers.

Still referring to FIG. 1, the template module 105 sends the event request with notification information 109 (instructions for the notification and recipient information) to the notification module 111. The notification module then proceeds to send the appropriate alert 107 over the proper communication means, depicted as the internet 103 in FIG. 1, which then becomes the alert sent to the user mobile device 101. An alternate operation occurs when the mobile device user 101 initiates a notification 106 from the device to other users of the system. The notification 106 creates an event 108 in the system that follows the same procedures as an event created by a third party application. The notification 106 comes back as an alert 107 to one or more different mobile device users.

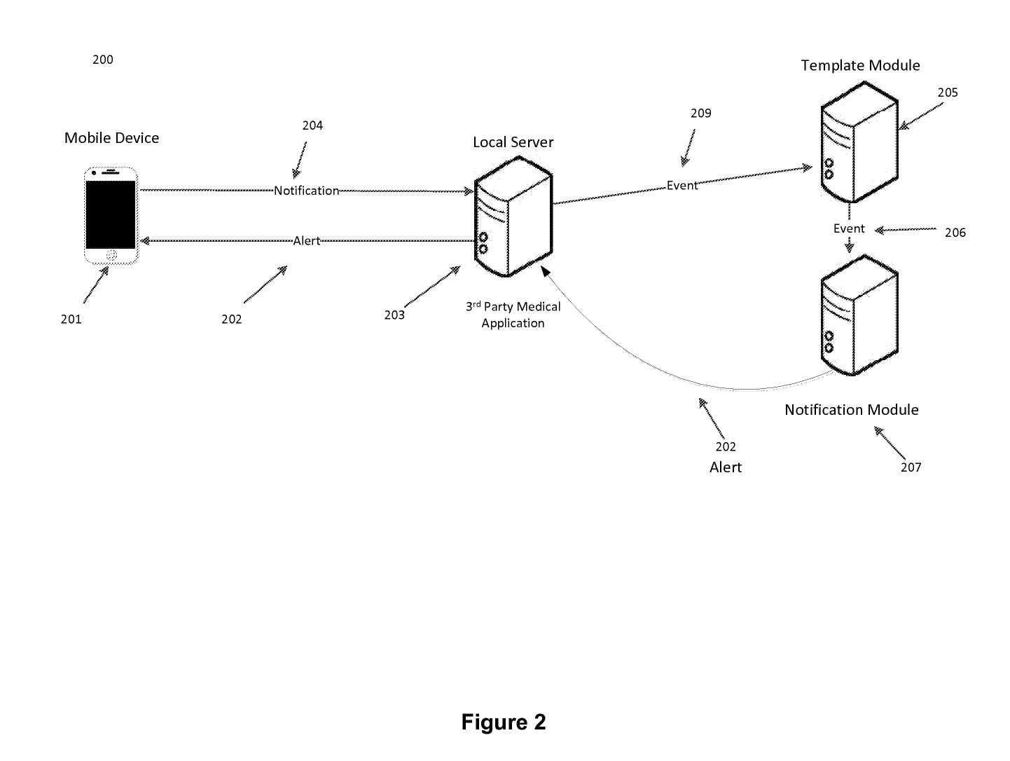

FIG. 2 illustrates an alternate embodiment of the system 200. In this configuration, the main server is a local server 203 that resides within the network of the system user, preferably a medical practice. The user of the mobile device 201 receives an alert 207 from the local server 203. It should be appreciated that local LAN communications may be accomplished by wired or wireless means, and alternately a cellular connection may be used. In response to an external event from a third party medical application, the local server 203 receives and validates the event request 209 and sends the event request to the template module 205. The template module 205 is configured to store templates of notification procedures, forwards the event request with event information 206 to the notification module 207. The template module and notification module are operationally coupled to the server.

Still referring to FIG. 2, the template module 205 sends the event request with notification information 209 (instructions for the notification and recipient information) to the notification module 207. The notification module then proceeds to send the appropriate alert 202 over the proper communication means, depicted as local network, which then becomes the alert sent to the user mobile device 202. An alternate operation occurs when the mobile device user 201 initiates a notification 204 from the device to other users of the system. The notification 204 creates an event 209 in the system that follows the same procedures as an event created by a third party application. The notification 204 comes back as an alert 202 to one or more different mobile device users.

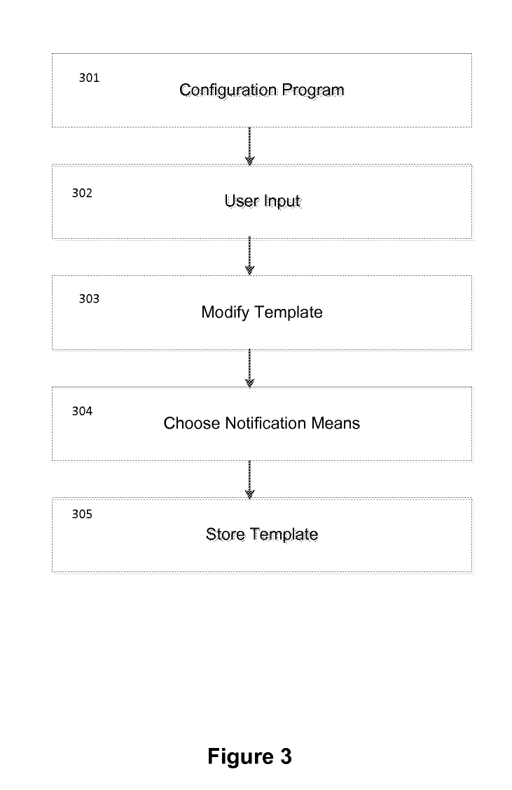

FIG. 3 is a flowchart that depicts a method that may be carried out in connection with the embodiments described herein. A configuration program 301 is provided to create a notification system. A user 302 will input into the configuration program, create or modify an existing template 303, choose a means of notification 304 for each user, and store the template 305.

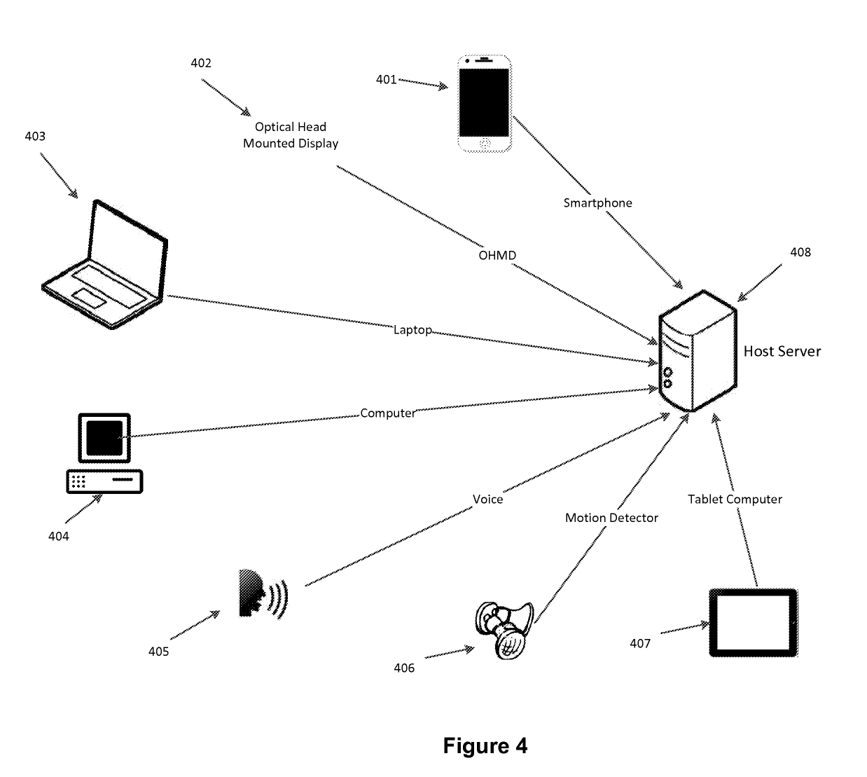

FIG. 4 illustrates various input methods that may be used according to one embodiment of the invention. FIG. 4 is shows a sampling of the mobile devices that may communicate with the host server 408 and send notifications and receive alerts. Devices shown include a smartphone 401, Optical Head Mounted Display 402, laptop computer 403, personal computer 404, voice recognition 405, motion detector 406, and tablet computer 407. The system is not limited to the devices shown in FIG. 4; any and other mobile computing devices that may one of send or receive messages may be used in the system. It should be appreciated that the mobile devices may send alerts without being triggered by an event, as well as sending alerts based on an event.

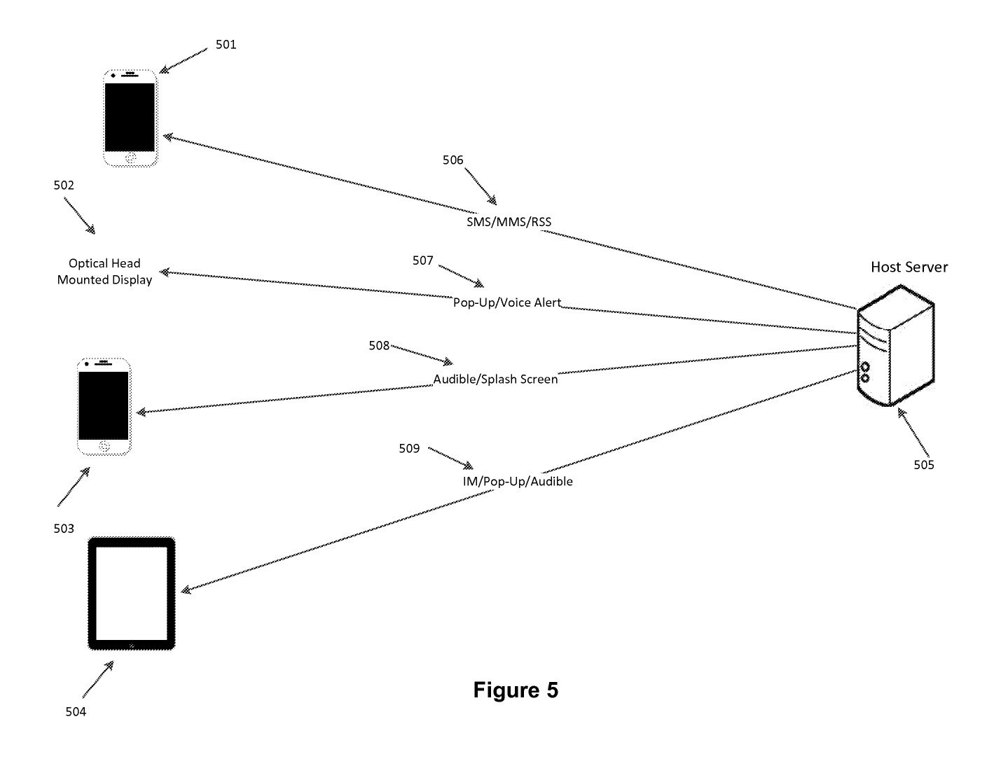

FIG. 5 illustrates various notification methods according to one embodiment of the invention. Various supported devices may input and receive alerts and notifications. It should be appreciated that any combination of alert type and device type is supported if the device supports an alert type. For example, a Optical Head Mounted display may receive an audible alert or pop-up alert, but may not have the capability to receive an SMS alert. Examples shown in FIG. 5 are as follows: a smartphone 501 receiving an SMS, MMS, or RSS alert 506; an OHMD 502 receiving a pop-up or voice alert 507; a smartphone 503 receiving an audible alert or splash screen alert 508; a tablet computer 504 receiving an Instant Message (IM), pop-up, or audible alert 509. All alerts originate from the host server 505.

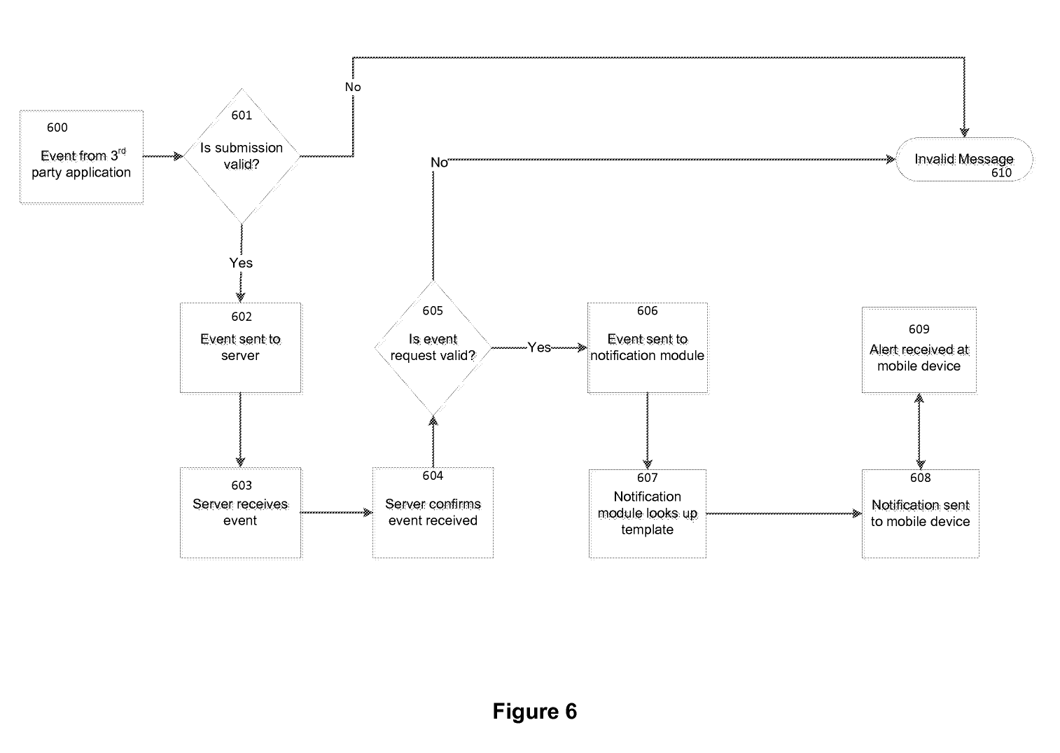

FIG. 6 illustrates a flowchart that depicts a method that may be carried out in connection with the embodiments described herein. An event 600 is received in the system from a third party application. The system checks the validity of the event submission 601: in the case the event is not valid, and invalid message 610 is returned; in the case the event is valid, the event is sent to the server for processing 602. The server receives the event 603 and confirms to the third party application that the event is received 604. The server then checks the validity of the event request: in the case of an invalid request, and invalid message 610 is returned to the third party application; in the case of a valid request, the event is sent to the notification module 606. The notification module 606 looks up the appropriate template 607 in the template module. The notification module then sends the alert 608 to the mobile device, and the alert is received 609 at the mobile device.

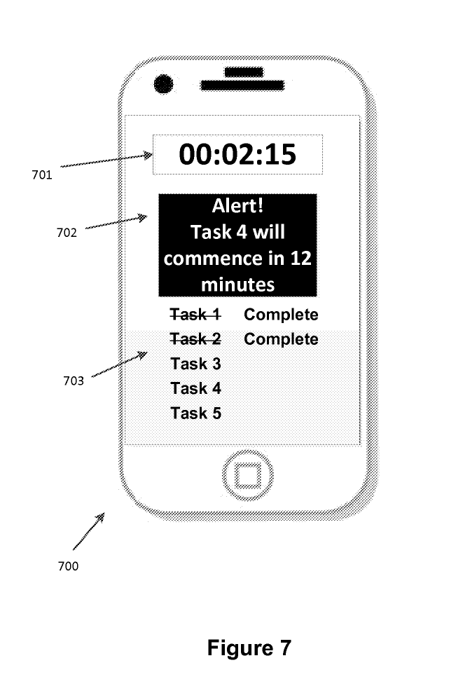

FIG. 7 illustrates a sample user interface 700 on a mobile computing device that may be carried out in connection with the embodiments described herein. A sample clinical procedure timeline is pictured. The timer of the current procedure 701 is shown, as well as the current task 703. A sample alert 702 is displayed to the user of the mobile device, in this case, an alert that an upcoming task will commence at a given time, thus giving warning to the user.

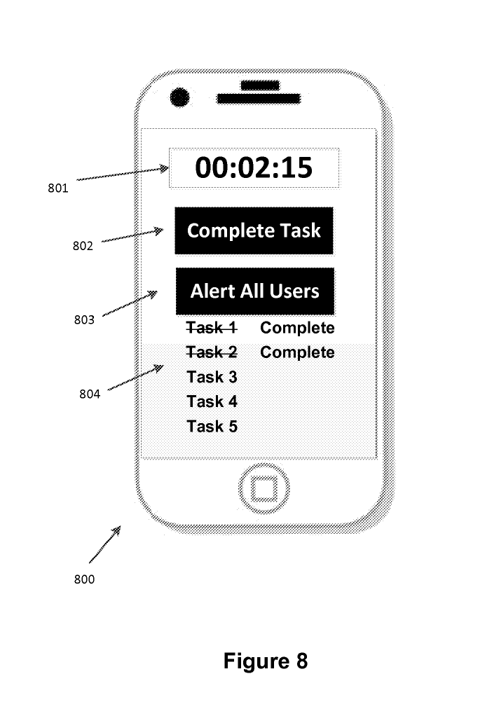

FIG. 8 illustrates an alternative sample user interface 800 on a mobile computing device that may be carried out in connection with the embodiments described herein. A sample clinical procedure timeline is pictured. The timer of the current procedure 802 is shown, as well as the current task 804. The mobile device user may activate a “complete task” option 802, which will generate a notification in the system. The user may also active an alert 803A sample alert to notify all users in the current procedure, or template, of the current status of the procedure.

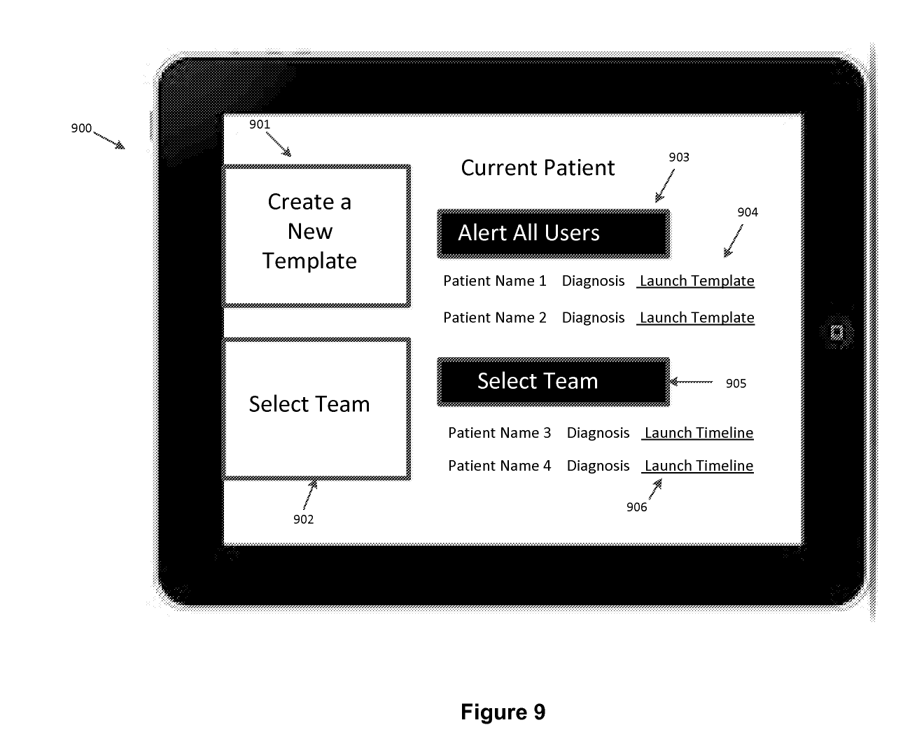

FIG. 9 illustrates another sample user interface 900 on a mobile computing device that may be carried out in connection with the embodiments described herein. The pictured screen depicts a system management function of creating a notification template. The user may create a new template 901, or select users for the team (users to be notified) 902. The user may also manage a current patient status by alerting all users 903, perhaps of a new patient, and launch a template 904. The user may also select a team of clinicians 905 and launch a new timeline 906 (new procedure for a new patient with a set of tasks).

It should be appreciated that a user may create custom templates using the system to fit specific procedures or goals, including custom user interfaces. A configuration program is provided for medical practices using the system to have the flexibility to create custom templates or modify provided templates to customize to their own procedure tasks and notification rules. Templates are stored either on the practices local server or on the cloud based host server.

Mobile devices may attach one or more of, video files, audio files, or other files that will become a permanent part of the patient record. Files may either be created by the user, for example, taking a photograph, or may be previously stored on the device.

1. A system for notifying medical practice personnel comprising:
a server configured to:
communicate with one or more mobile computing devices,
complete the real-time validation of user requests,
store notification templates,
operably interface with a third party medical patient platform, and
transmit the notification data to a mobile device client user interface;
a template module comprising:
templates of clinical procedure notification timelines, and
a first configuration program for a user to build one or more custom templates of clinical procedure notification timelines;
a notification module comprising a second configuration program for a user to input a means of event notification to one or more mobile computing devices based on the occurrence of an event; and wherein,
the one or more mobile computing devices are configured to one or more of receive a notification of an event and communicate with the server.

2. The system as described in claim 1, wherein the server further comprises the capability to:
communicate bi-directionally with one or more mobile computing devices over one or more of the following:
local area network,
wired internet means,
wireless internet means, and
cellular means; and
transmit notifications to one or more mobile device client user interfaces.

3. The system as described in claim 1, wherein:
the template module further:
provides the templates of clinical procedure notification timelines;
provides the first configuration program enabling a user to one or more of:
modify the one or more existing templates of clinical procedure notification timelines, and
build the one or more custom templates of clinical procedure notification timelines; wherein,
the clinical procedure notification timelines further comprises a rules based event and notification table that defines:
when the event notifications are transmitted, and
events that trigger each notification.

4. The system as described in claim 1, wherein the notification module is further adapted to provide the second configuration program, and wherein the event notification comprises one or more of: SMS, MMS, RSS, IM, audible alter, voice alert, splash screen, and pop up.

5. The system as described in claim 1, wherein the notification module further comprises the capability for a mobile computing device user to perform one or more of the following:
input an event into the system;
alert one or more mobile device users operationally coupled to the user based on an event,
alert one or more mobile device users operationally coupled to the user not based on an event, and
attach one or more files that will become a permanent part of the patient record, wherein the one or more files comprise:
video files,
audio files, and
other files.

6. The system as described in claim 1, wherein the one or more mobile computing devices comprise at least one of a: personal computer, mobile computing device, optical head mounted display device, voice recognition device, motion sensing device, and augmented reality device.

7. The system as described in claim 1, wherein the notification module:
further comprises at least one of a:
personal computer,
mobile computing device,
optical head mounted display device,
voice recognition device,
motion sensing device, and
augmented reality device; and
communicates bi-directionally with one or more input devices over one or more of a:
local area network,
wired internet means,
wireless internet means, and
cellular means; and
is operationally coupled to the server.

8. A method of notifying medical practice personnel comprising:
communicating with one or more mobile computing devices;
storing notification templates;
operably interfacing with any third party medical patient platform;
completing a real-time validation of user requests;
transmitting notification data to a device client user interface;
preforming at least one of
selecting a clinical procedure notification template, and
building one or more custom templates of clinical procedure notifications;
inputting a means of event notification to one or more of the mobile computing devices based on the occurrence of an event;
receiving a notification of an event at the one or more mobile computing devices; and
communicating with a server.

9. The method as described in claim 8, wherein, communicating with one or more mobile computing devices comprises communicating bi-directionally with one or more of the mobile computing devices over one or more of a:
local area network;
wired internet means;
wireless internet means; and
cellular means.

10. The method as described in claim 8, further comprising:
providing templates of clinical procedure notification timelines, wherein, the clinical procedure notification timelines comprise a rules-based event and notification table that defines:
when notifications are transmitted, and
events that trigger each notification;
providing a configuration program enabling a user to one or more of:
modify one or more existing templates, and
build one or more custom templates of clinical procedure notification timelines.

11. The method as described in claim 8, wherein, the notification means comprises one or more of:
SMS;
MMS;
RSS;
IM;
audible alert;
voice alert;
splash screen; and
pop up.

12. The method as described in claim 8, further comprising one or more of:
inputting an event into the system;
alerting one or more mobile device users operationally coupled to the user based on an event;
alerting one or more mobile device users operationally coupled to the user not based on an event; and
attaching as a permanent part of the patient record one or more of:
video files,
audio files, and
other files.

13. The method as described in claim 8, wherein,
communicating with one or more mobile computing devices comprises communicating bi-directionally with one or more of the following input devices:
personal computers,
mobile computing devices,
optical head mounted display devices,
voice recognition devices,
motion sensing devices, and
augmented reality devices; and
communicating with the input devices using one or more of the following:
local area network,
wired internet means,
wireless internet means, and
cellular means.

14. A non-transitory, tangible, computer readable storage medium, encoded with first processor readable instructions to perform the method of notifying medical practice personnel, the method comprising:
communicating with one or more mobile computing devices;
storing notification templates;
operably interfacing with any third party medical patient platform;
completing a real-time validation of user requests;
transmitting notification data to a device client user interface;
performing at least one of:
selecting a clinical procedure notification template, and
building one or more custom templates of clinical procedure notifications with a configuration program;
inputting a means of event notification to the one or more mobile computing devices based on an occurrence of an event;
receiving a notification of an event at the one or more mobile computing devices; and
communicating with a server.

15. The non-transitory, tangible, computer readable storage medium as described in claim 14 wherein, communicating with one or more mobile computing devices comprises communicating bi-directionally with one or more mobile computing devices over one or more:
local area network;
wired internet means;
wireless internet means; and
cellular means.

16. The non-transitory, tangible, computer readable storage medium as described in claim 14 wherein the method further comprises:
providing templates of clinical procedure notification timelines prior to storing notification timelines;
providing a configuration program after transmitting notification data to a device client user interface, wherein the configuration program is adapted to enable one or more of:
modifying one or more existing templates, and
the building one or more custom templates of clinical procedure notifications; and wherein, the templates of clinical procedure notification timelines comprise a rules based event and notification table that defines:
when notifications are transmitted, and
events that trigger each notification.

17. The non-transitory, tangible, computer readable storage medium as described in claim 14 wherein, inputting a means of event notification to the one or more mobile computing devices based on an occurrence of an event comprises one or more of a:
SMS;
MMS;
RSS;
IM;
audible alert;
voice alert;
splash screen; and
pop up.

18. The non-transitory, tangible, computer readable storage medium as described in claim 14 further comprising:
inputting an event into the system prior to inputting a means of event notification;
alerting the one or more mobile devices of an event; and
attaching as apart of the patient record one or more of:
video files,
audio files, and
other files.

19. The non-transitory, tangible, computer readable storage medium as described in claim 14 wherein,
communicating with one or more mobile computing devices comprises communicating bi-directionally with one or more of the following input devices:
personal computers,
mobile computing devices,
optical head mounted display devices,
voice recognition devices,
motion sensing devices, and
augmented reality devices; and further comprising,
communicating with the input devices using one or more of a:
local area network,
wired internet means,
wireless internet means, and
cellular means.
